(19) United States
(12) Patent Application Publication
(10) Pub. No.: US 2025/0368512 A1
(43) Pub. Date: Dec. 4, 2025

(54) Method for Producing Lithium Manganese Iron Phosphate

(71) Applicant: TOYOTA JIDOSHA KABUSHIKI KAISHA, Toyota-shi Aichi-ken (JP)

(72) Inventor: Takanori MAHARA, Toyota-shi Aichi-ken (JP)

(73) Assignee: TOYOTA JIDOSHA KABUSHIKI KAISHA, Toyota-shi Aichi-ken (JP)

(21) Appl. No.: 19/215,630

(22) Filed: May 22, 2025

(30) Foreign Application Priority Data
May 28, 2024 (JP) 2024-086178

(51) Int. Cl. C01B 25/37; H01M 10/0525

(52) U.S. Cl. CPC C01B 25/375; H01M 10/0525; C01P 2004/03; C01P 2006/40

(57) ABSTRACT

A method for producing lithium manganese iron phosphate, the method comprising: obtaining first precursor particles by mixing metal powder containing iron and manganese with a phosphate compound, and stirring and pulverizing; obtaining second precursor particles by mixing the first precursor particles with a lithium source, and stirring and pulverizing; and calcining the second precursor particles to obtain lithium manganese iron phosphate.

### CROSS REFERENCE TO RELATED APPLICATIONS

This nonprovisional application is based on Japanese Patent Application No. 2024-086178 filed on May 28, 2024, with the Japan Patent Office, the entire contents of which are hereby incorporated by reference.

### BACKGROUND

### Field

The present disclosure relates to a method for producing lithium manganese iron phosphate.

### Description of the Background Art

JP2014-65641A discloses a method for producing iron phosphate by reacting iron with phosphorus to produce a precipitate and washing the precipitate. It is also disclosed that lithium iron phosphate is produced by reacting the obtained iron phosphate with a lithium compound.

JP2016-81866A discloses a method for producing lithium manganese iron phosphate by hydrothermal reaction.

### SUMMARY

Lithium iron phosphate or lithium manganese iron phosphate is used as the positive electrode active material. As disclosed in JP2014-65641A, for lithium iron phosphate, iron phosphate is present as a suitable precursor. On the other hand, with respect to lithium manganese iron phosphate, there is no suitable precursor, and a method capable of producing lithium manganese iron phosphate at low cost has not been established.

As disclosed in JP2016-81866A, lithium manganese iron phosphate can be produced by hydrothermal reaction. On the other hand, in such a production method, it is necessary to use sulfate or the like, and it is necessary to discard sulfate or the like after the reaction.

An object of the present disclosure is to provide a method for producing lithium manganese iron phosphate capable of suppressing waste at low cost.

[1] A method for producing lithium manganese iron phosphate, the method comprising:
obtaining first precursor particles by mixing metal powder containing iron and manganese with a phosphate compound, and stirring and pulverizing;
obtaining second precursor particles by mixing the first precursor particles with a lithium source, and stirring and pulverizing; and
calcining the second precursor particles to obtain lithium manganese iron phosphate.

Lithium manganese iron phosphate is produced at low cost via a phosphate (precursor) by using a metal powder containing iron and manganese as a raw material, mixing with a phosphate compound, stirring, and grinding. In some embodiments, sulfate or the like may not be used in the production process, and waste can be suppressed. Further, it is expected to realize low energy through all the steps.

[2] The method for producing lithium manganese iron phosphate according to [1], wherein a molar ratio of iron and manganese to phosphorus in the second precursor particles is 5:4.

[3] The method for producing lithium manganese iron phosphate according to [1] or [2], wherein the metal powder is ferromanganese.

[4] The method for producing lithium manganese iron phosphate according to any one of [1] to [3], wherein in the obtaining second precursor particles, a carbon source is further added, and the mixture is stirred and pulverized.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a schematic flowchart of a method for producing lithium manganese iron phosphate in the present embodiment.

FIG. 2a is an explanatory view illustrating a step in the method for producing lithium manganese iron phosphate of the present embodiment.

FIG. 2b is an explanatory view illustrating another step in the method for producing lithium manganese iron phosphate of the present embodiment.

FIG. 2c is an explanatory view illustrating another step in the method for producing lithium manganese iron phosphate of the present embodiment.

FIG. 2d is an explanatory view illustrating another step in the method for producing lithium manganese iron phosphate of the present embodiment.

FIG. 2e is an explanatory view illustrating another step in the method for producing lithium manganese iron phosphate of the present embodiment.

FIG. 2f is an explanatory view illustrating another step in the method for producing lithium manganese iron phosphate of the present embodiment.

FIG. 3 is an example of an SEM image of lithium manganese iron phosphate of No. 1.

FIG. 4 is an example of an SEM image of lithium manganese iron phosphate of No. 2.

### DESCRIPTION OF THE EMBODIMENTS

Hereinafter, embodiments of the present disclosure (Hereinafter, it may be abbreviated as “the present embodiment”.) and examples of the present disclosure (Hereinafter, it can be abbreviated as “the present example”.) will be described. However, the present embodiment and the present example do not limit the technical scope of the present disclosure.

The lithium manganese iron phosphate produced in the present embodiment is suitably used, for example, as an electrode active material for secondary batteries, particularly as a positive electrode active material for non-aqueous electrolyte secondary batteries.

### <Method for Producing Lithium Manganese Iron Phosphate>

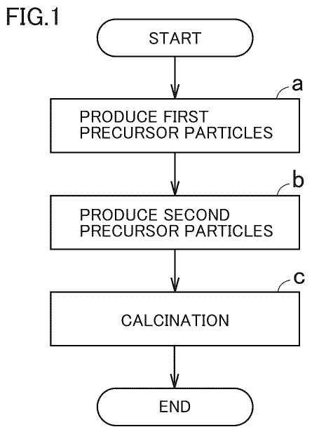

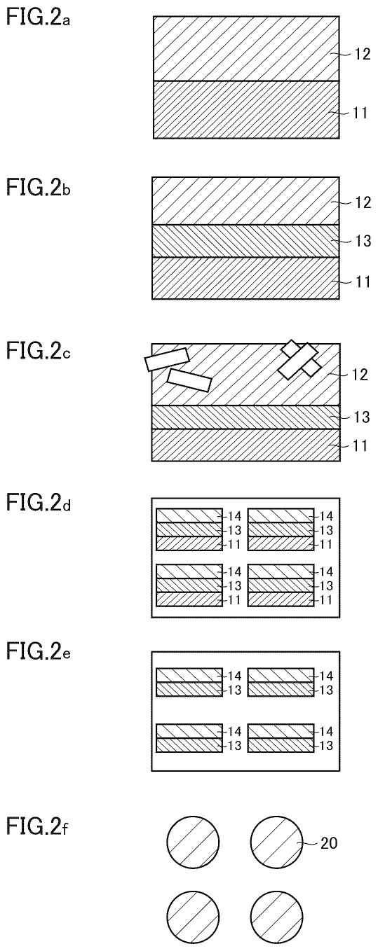

FIG. 1 is a schematic flowchart of a method for producing lithium manganese iron phosphate in the present embodiment. Hereinafter, “a method for producing lithium manganese iron phosphate in the present embodiment” may be abbreviated as “the present production method”. The present production method includes at least (a) a first precursor particle manufacturing step, (b) a second precursor particle manufacturing step, and (c) a baking step. Hereinafter, each step will be described with reference to FIG. 2a-2f.

### ((a) First Precursor Particle Production Method)

In the first precursor particle manufacturing process, a metal powder containing iron and manganese and a phosphate compound are mixed, stirred, and pulverized to obtain first precursor particles.

Examples of the metal powder containing iron and manganese include a powder obtained by mixing iron powder and manganese powder, and an iron-manganese alloy powder. In some embodiments, in the metal powder containing iron and manganese, when the number of moles of iron is a and the number of moles of manganese is b, a is greater than 0 and less than 0.5, and b is greater than 0.5 and less than 1. Lithium manganese iron phosphate produced by using such a metal powder is expected to contribute to improvement of characteristics of a secondary battery.

In some embodiments, as the iron-manganese alloy powder, ferromanganese is used. Ferromanganese is an iron-manganese alloy containing a high capacity of manganese, and is classified into high-carbon ferromanganese, medium-carbon ferromanganese, low-carbon ferromanganese and the like depending on the content of carbon (see JIS standard G2301). Ferromanganese is mass-produced worldwide, is available at low cost, and has aspect of being close to the composition of iron and manganese (iron:manganese=20 to 30:70 to 80 (molar ratio)) of lithium manganese iron phosphate currently used as a positive electrode active material.

Examples of the phosphate compound include phosphoric acid, ammonium dihydrogen phosphate, and diammonium hydrogen phosphate. In some embodiments, phosphoric acid is desirable from the viewpoint of enhancing battery characteristics, and a phosphoric acid aqueous solution of 70% by mass or more and 90% by mass or less is used.

In this step, a metal powder containing iron and manganese and a phosphate compound are mixed, stirred, and pulverized.

The stirring may be performed, for example, by adding a metal powder containing iron and manganese to water to prepare a slurry, and then dropping a phosphate compound. By dropping the phosphate compound into the slurry, a layer (first layer 11) of a metal powder containing iron and manganese and a layer (second layer 12) of the phosphate compound are first formed (FIG. 2a). Next, stirring is performed to form a coating film (third layer 13) of iron manganese phosphate by phosphorylation of the first layer 11 between the first layer 11 and the second layer 12 (FIG. 2b). The stirring speed when the phosphate compound is dropped may be, for example, 100 rpm or more and 1000 rpm or less. The stirring time is not particularly limited, but when ferromanganese is added to water, hydrogen is generated. Therefore, in some embodiments, stirring is continued until the generation of hydrogen is finished.

After stirring, the resulting slurry is ground. By pulverizing the obtained slurry, peeling of the second layer 12 and phosphorylation of the first layer 11 repeatedly occur (FIG. 2c). Thus, the first precursor particles are formed in the slurry. The pulverization may be performed by, for example, a ball mill, a bead mill, a planetary mill, a jet mill, a planetary mixer, a homogenizer, or the like. The pulverization time is not particularly limited, and may be, for example, 5 minutes or more and 60 minutes or less. After grinding, the slurry may be filtered.

### (B) Second Precursor Particle Production Method)

In the second precursor particle manufacturing process, the first precursor particle and the lithium source are mixed, stirred, and pulverized to obtain the second precursor particle.

Examples of the lithium source include lithium carbonate, lithium hydroxide, and lithium nitrate.

In this step, the first precursor particles and the lithium source are mixed, stirred, and pulverized.

The stirring may be performed, for example, while adding a lithium source to the slurry containing the first precursor particles obtained in the first precursor particle manufacturing process. By stirring while adding a lithium source to the slurry, a layer of lithium phosphate (2'nd layer 14) is formed (FIG. 2d). Here, the stirring speed when the lithium source is added may be, for example, 100 rpm or more and 500 rpm or less. On the other hand, it is considered that this step involves heat generation due to a neutralization reaction and foaming due to the use of a lithium source. Therefore, in some embodiments, in order to suppress heat generation and foaming, the stirring speed is slowed down the stirring speed. The stirring time is not particularly limited, but, in some embodiments, stirring is continued until the reaction is completed. In some embodiments, from the viewpoint of avoiding a rapid increase in pH, the lithium source is added over 15 minutes or more or over 30 minutes or more.

After stirring, the slurry is ground. By pulverizing the slurry, peeling of the 2'nd layer 14 and phosphorylation of the first layer 11 repeatedly occur. As a result, second precursor particles are formed in the slurry (FIG. 2e). The pulverization may be performed by, for example, a ball mill, a bead mill, a planetary mill, a jet mill, a planetary mixer, a homogenizer, or the like. The pulverization time is not particularly limited, and may be, for example, 30 minutes to 120 minutes. After grinding, the slurry may be filtered.

The molar ratio ((iron+manganese):phosphorus) of iron and manganese to phosphorus (phosphate) in the 2'nd layer 14 in the second precursor particle is, for example, 5:4, 3:2, or 1:1, and, in some embodiments, is 5:4. When the molar ratio is 5:4, lithium manganese iron phosphate having a small particle size and a large density is expected to be obtained.

In this step, a carbon source may be further added, followed by stirring and pulverization. Lithium manganese iron phosphate produced in the present embodiment is expected to be a positive electrode active material having high safety and suitable for obtaining a high-output non-aqueous electrolyte secondary battery. On the other hand, there is room for improvement in conductivity and diffusivity of lithium ions. In some embodiments, from this viewpoint, the surface of lithium manganese iron phosphate is coated with carbon. Accordingly, further improvement in battery characteristics is expected.

Examples of the carbon source include sugars such as glucose, fructose, starch, and cellulose. The addition amount of the carbon source may be, for example, 0.5 parts by mass or more and 15 parts by mass or less with respect to 100 parts by mass of the metal powder containing iron and manganese.

### ((c) Sintering Step)

In the firing step, the second precursor particles are fired to obtain lithium manganese iron phosphate 20 (FIG. 2f).

The firing temperature may be, for example, 500° C. or more and 1000° C. or less. If the firing temperature is too low, unreacted second precursor particles may remain or the crystallinity of the obtained lithium manganese iron phosphate may become insufficient. When the calcination temperature is too high, there is a concern that an irregular shape of lithium manganese iron phosphate increases.

The rate of temperature increase may be, for example, 1° C./min or more and 10° C./min or less. When the temperature rising rate is within the above range, the reaction proceeds without unevenness, and the crystallinity of the obtained lithium manganese iron phosphate is stabilized.

The firing time may be, for example, 1 hour or more and 12 hours or less. If the firing time is too short, unreacted second precursor particles may remain or the crystallinity of the obtained lithium manganese iron phosphate may become insufficient. When the calcination time is too long, there is a concern that an irregular shape of lithium manganese iron phosphate increases. Note that the firing time in the present disclosure refers to a time from the start of heating to the time when heating is performed at the maximum temperature after reaching the maximum temperature, and excludes a time until reaching the maximum temperature (temperature increase time) and a time when cooling to room temperature (30° C.) after heating at the maximum temperature is completed (cooling time).

The firing atmosphere may be, for example, an inert atmosphere containing argon, nitrogen, or the like.

### (Other Processes)

The present production method may include a drying step after the second precursor particle production step. In the present production method, any drying method may be used. For example, the slurry may be dried by a spray dryer or hot air.

### EMBODIMENTS

### <No. 1>

To 400 g of water was added 35.2 g of ferromanganese. Thereafter, 73 g of 85% by mass phosphoric acid was added dropwise and stirred at a speed of 200 rpm to obtain a slurry. Stirring was performed for 1 hour until hydrogen evolution ceased.

The resulting slurry was loaded into a planetary mill and pulverized for 15 minutes using 5 mm beads. The pulverized slurry was filtered using a filter having an opening of 75 μm.

To the filtered slurry, 23.5 g of lithium carbonate was added over 30 minutes, and the mixture was stirred at a speed of 200 rpm. After that, 9 g of fructose was added and dissolved by stirring for 30 minutes to obtain a slurry.

The obtained slurry was charged into a bead mill (Super Apex Mill manufactured by Metal & Machinery Co., Ltd.) and pulverized for 90 minutes using 0.1 mm beads. The pulverized slurry was filtered using a filter having an opening of 75 μm.

The filtered slurry was dried using a spray dryer.

The dried second precursor particles were calcined in an argon atmosphere at a rate of temperature increase of 5° C./min at a calcination temperature of 680° C. for 3 hours. The calcined particles were sieved through a filter having an opening of 75 μm to obtain lithium manganese iron phosphate (positive electrode active material) of No. 1.

### <No. 2>

Lithium manganese iron phosphate (positive electrode active material) of No. 2 was obtained using the same material and method as those of No. 1, except that 23.5 g of lithium carbonate was added in total at one time.

### <Analysis>

Each of the second precursor particles after drying by the spray dryer of Nos. 1 and 2 was irradiated with X-rays by an X-ray diffraction (XRD) apparatus to confirm the molar ratio ((iron+manganese):phosphorus) of iron and manganese to phosphorus in the second precursor particles. In No. 1, (iron+manganese):phosphorus is 5:4, in No. 2 (iron+manganese):phosphorus was 3:2.

### <Observation>

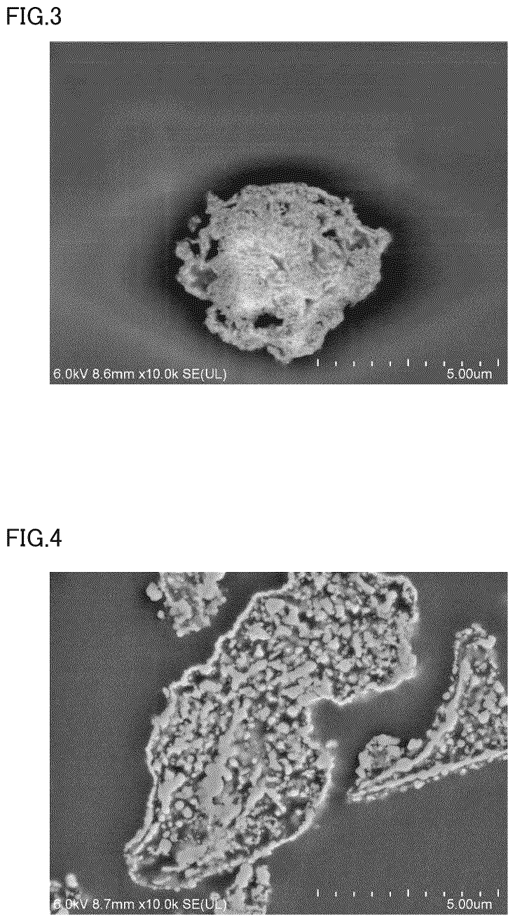

Lithium manganese iron phosphate of Nos. 1 and 2 was observed by SEM (Scanning Electron Microscope) (magnification: 10,000 times). SEM images of each No. are shown in FIGS. 3 and 4.

As shown in FIGS. 3 and 4, the lithium manganese iron phosphate of No. 1 was fine particles having a particle diameter smaller than that of the lithium manganese iron phosphate of No. 2. In general, it is considered that a positive electrode active material having a small particle diameter contributes to improvement in characteristics of a secondary battery as compared with a positive electrode active material having a large particle diameter. That is, the lithium manganese iron phosphate of No. 1 is expected to contribute to the improvement of the characteristics of the secondary battery more than the lithium manganese iron phosphate of No. 2.

In addition, the lithium manganese iron phosphate obtained above is obtained via a phosphate (precursor), and is expected to be produced at low cost. Furthermore, since sulfate or the like is not used in the manufacturing process, waste can be suppressed.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A method for producing lithium manganese iron phosphate, the method comprising:
obtaining first precursor particles by mixing metal powder containing iron and manganese with a phosphate compound, and stirring and pulverizing;
obtaining second precursor particles by mixing the first precursor particles with a lithium source, and stirring and pulverizing; and
calcining the second precursor particles to obtain lithium manganese iron phosphate.

2. The method for producing lithium manganese iron phosphate according to claim 1, wherein a molar ratio of iron and manganese to phosphorus in the second precursor particles is 5:4.

3. The method for producing lithium manganese iron phosphate according to claim 1, wherein the metal powder is ferromanganese.

4. The method for producing lithium manganese iron phosphate according to claim 1, wherein in the obtaining second precursor particles, a carbon source is further added, and the mixture is stirred and pulverized.
